(19) United States
(12) Patent Application Publication
(10) Pub. No.: US 2026/0216822 A1
(43) Pub. Date: Jul. 30, 2026

(54) LASER WELDED JOINT AND MANUFACTURING METHOD OF LASER WELDED JOINT

(71) Applicant: NIPPON STEEL CORPORATION, Tokyo (JP)

(72) Inventors: Hajime ASHIDA, Tokyo (JP); Hiroki FUJIMOTO, Tokyo (JP)

(73) Assignee: NIPPON STEEL CORPORATION, Tokyo (JP)

(21) Appl. No.: 19/145,333

(22) PCT Filed: Jan. 19, 2024
(86) PCT No.: PCT/JP2024/001462

§ 371 Date: Jul. 2, 2025

(30) Foreign Application Priority Data
Jan. 20, 2023 (JP) 2023-007149

(51) Int. Cl. B23K 26/211; B23K 26/32; B23K 35/30; B23K 103/04

(52) U.S. Cl. CPC B23K 26/211; B23K 26/32; B23K 35/3026; B23K 2103/04

(57) ABSTRACT

A laser welded joint (1) including: a plurality of steel sheets (11) and (12); and a weld metal (20) configured to join the plurality of steel sheets (11) and (12), in which at least one of the plurality of steel sheets (11) and (12) is a high strength steel sheet having Vickers hardness of 320 HV or more, an amount of Al penetrated from base metal of the plurality of steel sheets (11) and (12) is more than 0.10 mass % and 2.10 mass % or less, an average Al content of the weld metal (20) is 0.30 mass % or more and 2.00 mass % or less, when the average Al content, an average Si content, and an average Mn content of the weld metal (20) are denoted by [Al], [Si], and [Mn], Expression (1) ([Al]/([Al]+[Si]+[Mn])≥0.150) is satisfied, and slag containing Al covers 30.0% or more of a surface of the weld metal (20), and a manufacturing method thereof.

### TECHNICAL FIELD

The present invention relates to a laser welded joint and a manufacturing method of the laser welded joint.

Priority is claimed on Japanese Patent Application No. 2023-007149, filed Jan. 20, 2023, the content of which is incorporated herein by reference.

### BACKGROUND ART

To produce laser welded joints, a plurality of steel sheets are arranged so that they are overlapped or their end parts are butted against each other, a joint part is irradiated with laser beams to melt the steel sheets and a filler in the portion irradiated with laser beams, and the melted metal is solidified to form a weld metal, so that the laser welded joints have a structure in which the plurality of steel sheets are joined by the weld metal.

### CITATION LIST

### Patent Document

Patent Document 1: Japanese Unexamined Patent Application, First Publication No. 2011-31249

### SUMMARY OF INVENTION

### Technical Problem

Laser welded parts of high strength steel sheets having a strength of 980 MPa or more, which have been used in recent years for the purpose of improving the strength and stiffness of vehicle bodies, contain a large amount of carbon, and thus have problems in that the weld metal is likely to harden and cold-cracking (cracking due to hydrogen embrittlement) is likely to occur at a terminal end part of the weld metal. In a case where such cracking occurs, the cracking propagates over the entire length of the weld metal formed primarily in a linear shape. Therefore, not only the static strength of the welded joint, such as shear strength and peeling strength, decreases, but the fatigue strength also significantly decreases. Therefore, a method of preventing cold-cracking in the laser welded part of the high strength steel sheet is required.

In addition, in laser welded joints of the related art, the weld metal embrittles due to diffusible hydrogen that has intruded during welding, and thus cracking may occur during the course of forming after production of the laser welded joint, or occur after welding during assembling of components. Therefore, a method of reducing diffusible hydrogen in the laser welded part or a method of improving the hydrogen embrittlement resistance of the laser welded part is required.

Meanwhile, as in Patent Document 1, it has been reported that a filler that is added during welding lowers the hardness of a welded part, and thus cold-cracking rarely occurs in the welded part. However, a problem occurs in that the strength (hardness) of the welded part decreases.

The present invention has been made in view of the above circumstances, and an object thereof is to provide a laser welded joint in which cold-cracking is suppressed and a strength of the joint is ensured, and a manufacturing method thereof.

### Solution to Problem

(1) A laser welded joint according to an aspect of the present invention is a laser welded joint including: a plurality of steel sheets; and a weld metal configured to join the plurality of steel sheets,
in which at least one of the plurality of steel sheets is a high strength steel sheet having Vickers hardness of 320 HV or more,
an amount of Al penetrated from base metal of the plurality of steel sheets is more than 0.10 mass % and 2.10 mass % or less,
an average Al content of the weld metal is 0.30 mass % or more and 2.00 mass % or less,
when the average Al content, an average Si content, and an average Mn content of the weld metal are denoted by [Al], [Si], and [Mn], the following Expression (1) is satisfied, and
slag containing Al covers 30.0% or more of a surface of the weld metal.

$$[ Al ] / ( [ Al ] + [ Si ] + [ Mn ] ) \geq 0.15 \qquad Expression 1$$

(2) In the laser welded joint according to (1), a ratio of the average Al content of the weld metal to the amount of Al penetrated from base metal of the plurality of steel sheets may be 0.80 to 1.20.

(3) In the laser welded joint according to (1) or (2), the weld metal may contain, as a chemical composition, by mass %,
C: 0.1% to 0.6%,
Si: 0.005% to 3.0%,
Mn: 0.5% to 3.0%,
Al: 0.30% to 2.00%,
P: 0.04% or less,
S: 0.01% or less,
N: 0.1% or less,
O: 0.1% or less,
Cu: 0% to 1.0%,
Nb+Ti+V: 0% to 0.3%,
Ca+REM: 0% to 0.01%,
B: 0% to 0.005%,
Cr: 0% to 2.0%,
Ni: 0% to 1.0%,
Mo: 0% to 1.0%,
Sn: 0.1% or less,
Mg: 0% to 0.01%,
Sb: 0% to 0.1%,
As: 0% to 0.1%, and
a remainder: Fe and impurities.

(4) In the laser welded joint according to any one of (1) to (3), at least one of the plurality of steel sheets may be a non-plated steel sheet or a zinc-based plated steel sheet.

(5) In the laser welded joint according to any one of (1) to (4), Vickers hardness of the weld metal may be 450 HV or more.

(6) In the laser welded joint according to any one of (1) to (5), the laser welded joint may be a laser lap welded joint, a laser butt welded joint, or a laser fillet welded joint.

(7) In the laser welded joint according to any one of (1) to (6), at least one of the plurality of steel sheets may be a high strength steel sheet having a tensile strength of 980 MPa or more.

(8) In the laser welded joint according to any one of (1) to (7), one or more of the plurality of steel sheets may contain, as a chemical composition, by mass %,
C: more than 0.15% and 0.5% or less,
Si: 0.1% to 3.5%,
Mn: 0.2% to 5.5%,
Al: more than 0.10% and 2.10% or less,
N: 0.1% or less,
O: 0.1% or less,
P+S: 0.050% or less,
Cu: 0% to 1.0%,
Nb+Ti+V: 0% to 0.3%,
Ca+REM: 0% to 0.01%,
B: 0% to 0.005%,
Cr: 0% to 2.0%,
Ni: 0% to 1.0%,
Mo: 0% to 1.0%,
Sn: 0.1% or less,
Mg: 0% to 0.01%,
Sb: 0% to 0.1%,
As: 0% to 0.1%, and
a remainder of Fe and impurities.

(9) A manufacturing method of a laser welded joint according to an aspect of the present invention is a manufacturing method of the laser welded joint according to any one of (1) to (8), including: a step of preparing the plurality of steel sheets; a step of arranging the plurality of steel sheets; and a laser welding step of forming the weld metal for joining the plurality of steel sheets, in which laser welding is performed in an environment having an oxygen concentration of 3.0% or more in the laser welding step.

(10) In the manufacturing method of the laser welded joint according to (9), a solid laser device or a semiconductor laser device may be used as a laser beam source in the laser welding step.

### Advantageous Effects of Invention

According to the laser welded joint and the manufacturing method thereof according to the present invention, it is possible to suppress cold-cracking and ensure a strength of the joint.

### BRIEF DESCRIPTION OF DRAWINGS

FIG. 1 A schematic view of a cut end surface for explaining a laser lap welded joint.

FIG. 2 A schematic plan view of a laser welded joint 1, viewed from the positive direction side in the Z-coordinate axis of FIG. 1.

FIG. 3 A schematic view of a cut end surface for explaining a laser butt welded joint.

FIG. 4 A schematic plan view of a laser welded joint 1, viewed from the positive direction side in the Z-coordinate axis of FIG. 3.

FIG. 5 A schematic view of a cut end surface for explaining a laser fillet welded T-joint.

FIG. 6 A schematic plan view of a laser welded joint 1, viewed from the positive direction side in the Z-coordinate axis of FIG. 5.

FIG. 7 A schematic view of a cut end surface for explaining a laser lap fillet welded joint.

FIG. 8 A schematic plan view of a laser welded joint 1, viewed from the positive direction side in the Z-coordinate axis of FIG. 7.

FIG. 9 A schematic view of a cut end surface for explaining a penetration cross-section area of a steel sheet in a laser lap welded joint.

FIG. 10 A schematic view of a cut end surface for explaining a penetration cross-section area of a steel sheet in a laser butt welded joint.

FIG. 11 A schematic view of a cut end surface for explaining a penetration cross-section area of a steel sheet in a laser fillet welded T-joint.

FIG. 12 A schematic view of a cut end surface for explaining a penetration cross-section area of a steel sheet in a laser lap fillet welded joint.

FIG. 13 (A) shows an example of an SEM image of a measurement portion, and (B) shows an example of an image obtained by binarizing a mapping image of Al at the measurement portion of (A).

FIG. 14 (A) shows an example of an SEM image of a measurement portion, and (B) shows another example of an image obtained by binarizing a mapping image of Al at the measurement portion of (A).

### DESCRIPTION OF EMBODIMENTS

In general, cold-cracking is considered to occur when three elements, i.e., diffusible hydrogen that has intruded a welded part, tensile stress applied to the welded part, and structure hardening in the welded part overlap and exceed their limits. The present inventors conducted studies to reduce the diffusible hydrogen among the above elements. The present inventors found that, by adding aluminum (Al) to a steel sheet to be joined, the surface of a molten pool during laser welding is covered with slag containing Al, it is possible to make it difficult for a gas containing diffusible hydrogen to come into contact with the molten pool, and thus it is possible to prevent the intrusion of hydrogen into the molten pool. As a result, the present inventors reached an idea that it is possible to prevent cold-cracking in a laser welded part. The present inventors also found that, in a case where the steel sheet mainly serves as a source of Al to the weld metal instead of a filler or the like, it is possible to further improve the cold-cracking prevention effect without a decrease in strength of the welded part.

Hereinafter, embodiments of the present invention will be described with reference to examples, but it is obvious that the present invention is not limited to the examples to be described below. In the following description, specific numerical values and materials may be provided as examples, but other numerical values and materials may be applied as long as the effect of the present invention can be obtained. In addition, constituent elements of the following embodiments can be combined with each other.

In addition, in the present specification, a numerical value range expressed using “to” means a range including numerical values described before and after “to” as a lower limit and an upper limit. In the present specification, the term “step” includes not only an independent step but also a step where the intended purpose thereof is achieved, even in a case where it cannot be clearly distinguished from another step.

### [Laser Welded Joint]

A laser welded joint according to the present embodiment includes a plurality of steel sheets and a weld metal that joins the plurality of steel sheets.

### (Steel Sheet)

The plurality of steel sheets are base metals of the laser welded joint. The thickness of the steel sheet (also referred to as the sheet thickness) is not particularly limited as long as it is suitable for laser welding. The number of steel sheets is not particularly limited, and can be set to any number of two or more. In the following examples, a laser welded joint in which two steel sheets are joined through a weld metal will be described as an example.

In the laser welded joint according to the present embodiment, one or more steel sheets of the plurality of steel sheets may contain, as a chemical composition, by mass %, C: more than 0.15% and 0.5% or less, Si: 0.1% to 3.5%, Mn: 0.2% to 5.5%, Al: more than 0.10% and 2.10% or less, N: 0.1% or less, O: 0.1% or less, P+S: 0.050% or less, Cu: 0% to 1.0%, Nb+Ti+V: 0% to 0.3%, Ca+REM: 0% to 0.01%, B: 0% to 0.005%, Cr: 0% to 2.0%, Ni: 0% to 1.0%, Mo: 0% to 1.0%, Sn: 0.1% or less, Mg: 0% to 0.01%, Sb: 0% to 0.1%, As: 0% to 0.1%, and a remainder including Fe and impurities. The steel sheet having such a chemical composition has a high strength, and thus can impart an excellent strength to the laser welded joint.

The chemical composition of the steel sheet described above is determined by preparing a sample and performing quantitative analysis according to the standards described in Table 1 of JIS G 0321 (2010). As a sample used for measurement of the chemical composition, a portion (preferable portion) 5 mm or more away from the welded part of the steel sheet is collected, and measured values are obtained in this sample. In a case where the steel sheet is provided with a plating layer on a surface thereof, the chemical composition may be analyzed after removing the plating layer by mechanical grinding.

### (Weld Metal)

The weld metal is a portion where the steel sheet or the like is melted and solidified by laser beam irradiation during laser welding, and is metal melted and solidified during welding in a part of the welded part. In a case where a filler (filler material) is not used during laser welding, the plurality of steel sheets to be joined serve as a source of the material of the weld metal. In a case where a filler is used during laser welding, the plurality of steel sheets to be joined and the filler serve as a source of the material of the weld metal. In a case where the steel sheet is plated, the plating component is also melted and becomes a material constituting the weld metal. In addition to the elements from the sources, oxygen or nitrogen in the air may be incorporated into the weld metal. Inevitable impurities may also be incorporated thereinto.

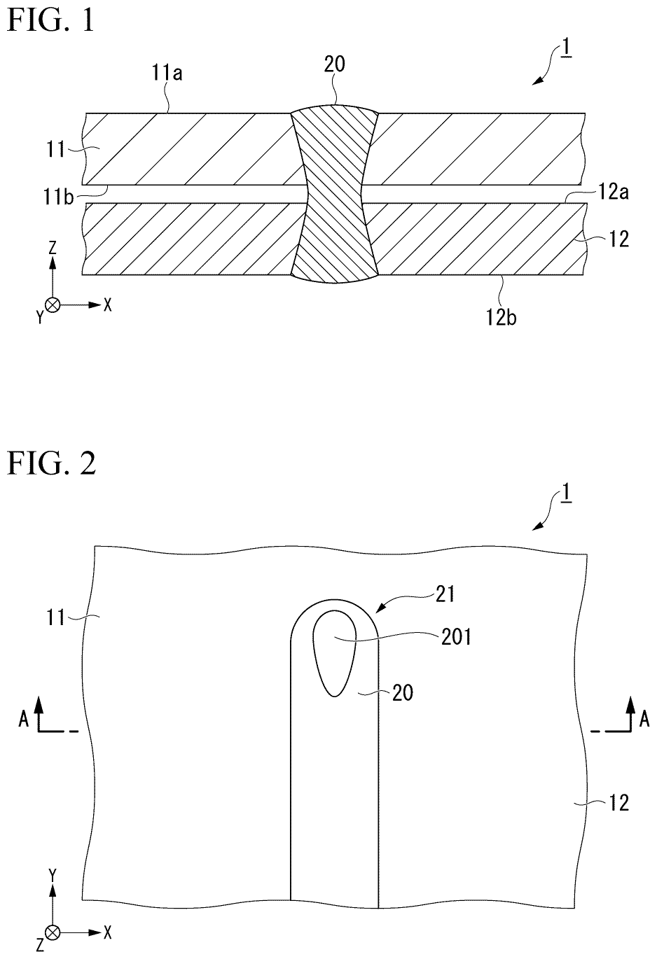

FIGS. 1 to 8 show various forms of the laser welded joint according to the present embodiment. However, the laser welded joint to which the present invention is applied is not limited to these examples, and the present invention can be applied to laser welded joints having any shape and manufacturing methods thereof, so long as the requirements of the present invention are satisfied. In addition, the X-coordinate axis, the Y-coordinate axis, and the Z-coordinate axis of FIGS. 1 to 8 are orthogonal to each other.

### (Laser Lap Welded Joint)

FIG. 1 is a schematic view of a cut end surface for explaining a laser lap welded joint in which steel sheets that are joined at least partially overlap each other. A cut surface of a laser welded joint 1 in FIG. 1 is a surface perpendicular to the extension direction of a weld metal (the direction along a weld line) and parallel to the X-coordinate axis and the Z-coordinate axis. The laser welded joint 1 shown in FIG. 1 includes a steel sheet 11, a steel sheet 12 overlapped with the steel sheet 11, and a weld metal 20 formed over the steel sheet 11 and the steel sheet 12 in a sheet thickness direction. The steel sheet 11 has one sheet surface 11a and the other sheet surface 11b. The steel sheet 12 has one sheet surface 12a and the other sheet surface 12b. In this example, the sheet surface 11b of the steel sheet 11 and the sheet surface 12a of the steel sheet 12 are opposed to each other.

The example shown in FIG. 1 shows an example in which laser beams are irradiated from the sheet surface 11a side (the positive direction side in the Z-coordinate axis) of the steel sheet 11 to form the weld metal 20. In the example of FIG. 1, the weld metal 20 is formed over the whole sheet thickness direction of the steel sheet 11 and the steel sheet 12. However, the laser lap welded joint is not limited to the example of FIG. 1. The weld metal 20 may be formed over the whole sheet thickness direction of the steel sheet 11, and may be formed from one sheet surface 12a of the steel sheet 12 to the midway portion in the sheet thickness direction toward the sheet surface 12b.

FIG. 2 is a schematic plan view of the laser welded joint 1, viewed from the positive direction side in the Z-coordinate axis of FIG. 1. FIG. 1 is a view of a cut end surface of the laser welded joint 1 shown in FIG. 2, broken along the cross-sectional line A-A. The weld metal 20 is formed to extend along the Y-coordinate axis in the example of FIG. 2. The traveling direction of laser beams in the formation of the weld metal 20 is in the positive direction of the Y coordinate axis. A crater 201 is present in a terminal end part 21 of the weld metal 20.

In general, a molten metal flows in a direction opposite to the traveling direction of laser beams in laser welding. Therefore, a dimple called a crater is formed in a terminal end part of a weld metal (also referred to as a bead) formed by laser welding. The terminal end part of the weld metal formed by laser welding is a final solidification part of the weld metal, and in this portion, a crater is formed due to a shortage of the molten metal.

### (Laser Butt Welded Joint)

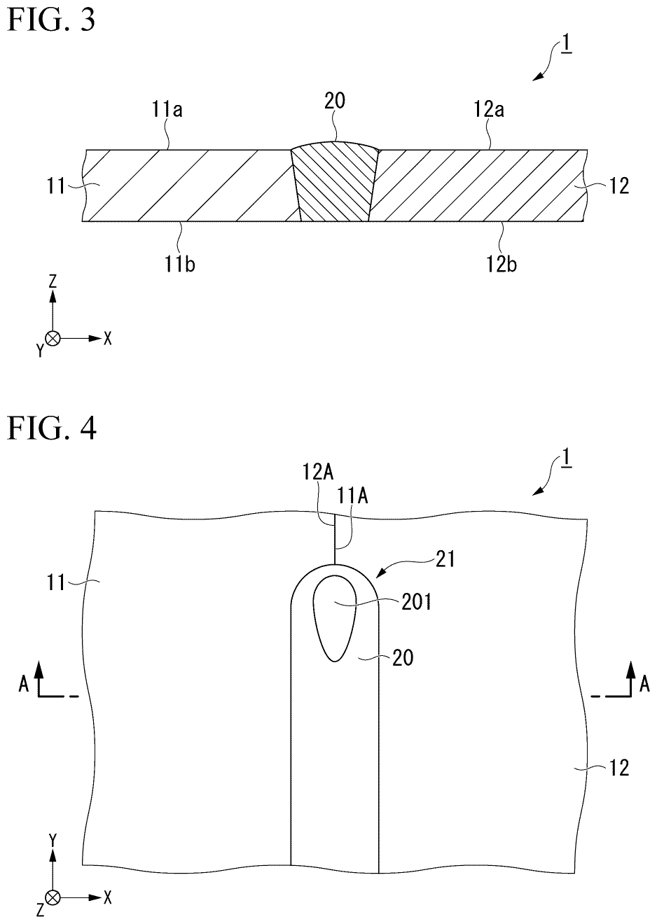

FIG. 3 is a schematic view of a cut end surface for explaining a laser butt welded joint in which end surfaces of steel sheets that are joined face each other. A cut surface of a laser welded joint 1 in FIG. 3 is a surface perpendicular to the extension direction of a weld metal (the traveling direction of laser beams) and parallel to the X-coordinate axis and the Z-coordinate axis. The laser welded joint 1 shown in FIG. 3 includes a steel sheet 11 and a steel sheet 12 disposed so that end surfaces thereof are butted against each other, and a weld metal 20 that joins the steel sheet 11 and the steel sheet 12 in a direction parallel to sheet surfaces of the steel sheets 11 and 12. The steel sheet 11 has one sheet surface 11a and the other sheet surface 11b. The steel sheet 12 has one sheet surface 12a and the other sheet surface 12b. In this example, the sheet surface 11a of the steel sheet 11 and the sheet surface 12a of the steel sheet 12 face in the same direction.

The example shown in FIG. 3 shows an example in which laser beams are irradiated from the sheet surface 11a side (the positive direction side in the Z-coordinate axis) of the steel sheet 11 to form the weld metal 20. In the example of FIG. 3, the weld metal 20 is formed over the whole sheet thickness direction of the steel sheet 11 and the steel sheet 12. However, the laser butt welded joint is not limited to the example of FIG. 3, and the weld metal 20 may be formed to the midway portion in the sheet thickness direction of the steel sheet 11 and the steel sheet 12.

FIG. 4 is a schematic plan view of the laser welded joint 1, viewed from the positive direction side in the Z-coordinate axis of FIG. 3. FIG. 3 is a view of a cut end surface of the laser welded joint 1 shown in FIG. 4, broken along the cross-sectional line A-A. The weld metal 20 is formed to extend along the Y-coordinate axis in the example of FIG. 4. In addition, the end surface 11A of the steel sheet 11 and the end surface 12A of the steel sheet 12 are butted against each other. The traveling direction of laser beams in the formation of the weld metal 20 is in the positive direction of the Y coordinate axis. A crater 201 is present in a terminal end part 21 of the weld metal 20.

In the example of FIG. 4, the steel sheet 11 and the steel sheet 12 have linear end surfaces, and the weld metal 20 is formed along the end surfaces. The weld metal 20 may be formed over the whole end surfaces of the steel sheets butted against each other, or may be formed intermittently or partially on the end surfaces of the steel sheets butted against each other. In addition, the shapes of the end surfaces of the joined steel sheets are not limited to the linear shape. The steel sheets may have a predetermined shape required for a component to be manufactured.

In addition, the end surfaces of the steel sheets butted against each other may be in contact with each other, or a gap may be provided therebetween.

### (Laser Fillet Welded Joint)

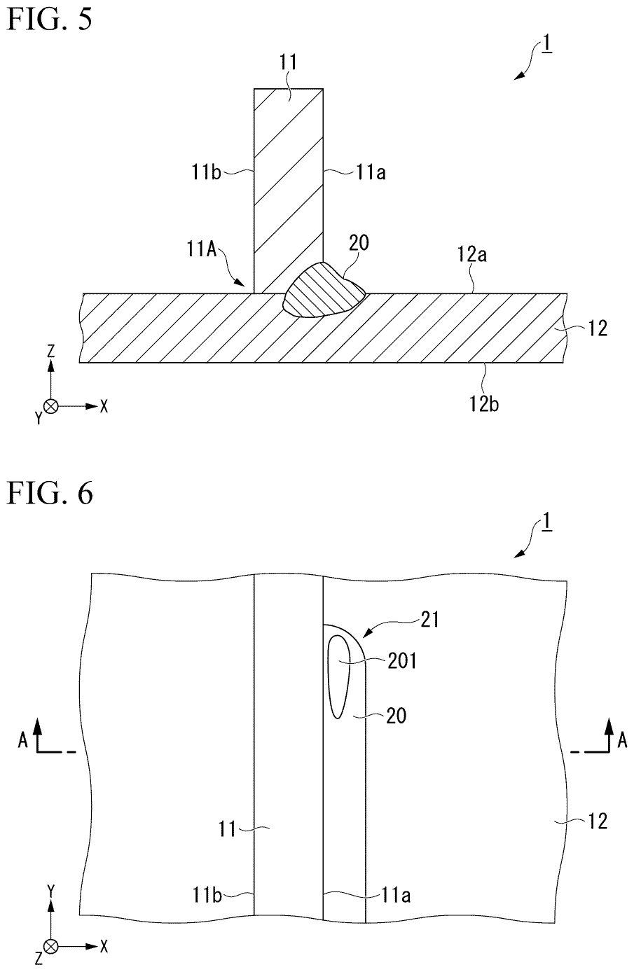

FIG. 5 is a schematic view of a cut end surface for explaining a laser fillet welded joint (also referred to as a laser fillet welded T-joint) in which a sheet surface of one steel sheet is joined to an end surface of the other steel sheet and a weld metal is formed in a corner part formed of sheet surfaces of the steel sheets. A steel sheet 11 of FIG. 5 has one sheet surface 11a and the other sheet surface 11b. A steel sheet 12 has one sheet surface 12a and the other sheet surface 12b. In a laser welded joint 1 shown in FIG. 5, the sheet surface of the steel sheet 11 and the sheet surface of the steel sheet 12 are disposed perpendicular to each other, the end surface 11A of the steel sheet 11 is in contact with the sheet surface 12a of the steel sheet 12, and a weld metal 20 is formed in a corner part formed by the steel sheet 11 and the steel sheet 12. A cut surface of the laser welded joint 1 in FIG. 5 is a surface perpendicular to the extension direction of the weld metal (the traveling direction of laser beams) and parallel to the X-coordinate axis and the Z-coordinate axis.

The positional relationship between the sheet surface of the steel sheet 11 and the sheet surface of the steel sheet 12 is not limited to the perpendicular relationship, and a positional relationship in which the sheet surfaces intersect with each other may be made. In addition, the end surface of one steel sheet may not be in contact with the sheet surface of the other steel sheet, and a gap may be provided between the steel sheets. The weld metal 20 may be formed over the entire length of the corner part, or may be formed intermittently or partially along the corner part. In addition, the shapes of the end surfaces of the joined steel sheets are not limited to the linear shape. The steel sheets may have a predetermined shape required for a component to be manufactured. In addition, the sheet surfaces of the joined steel sheets are not limited to flat surfaces, and may have partial irregularities, notches, or the like.

In the example of FIG. 5, the weld metal 20 is formed from the sheet surface 11a of the steel sheet 11 and the sheet surface 12a of the steel sheet 12 to the midway portion in the sheet thickness direction.

FIG. 6 is a schematic plan view of the laser welded joint 1, viewed from the positive direction side in the Z-coordinate axis of FIG. 5. FIG. 5 is a view of a cut end surface of the laser welded joint 1 shown in FIG. 6, broken along the cross-sectional line A-A. The weld metal 20 is formed to extend along the Y-coordinate axis in the example of FIG. 6. The traveling direction of laser beams in the formation of the weld metal 20 is in the positive direction of the Y coordinate axis. A crater 201 is present in a terminal end part 21 of the weld metal 20.

As another form of the laser welded joint 1 illustrated in FIGS. 5 and 6, the weld metal 20 may be formed on both the sheet surfaces 11a and 11b of the steel sheet 11. Such a weld metal 20 can be formed by, for example, sequentially applying laser beams from the positive direction side and the negative direction side of the X-coordinate axis of FIG. 5. In addition, in such a laser welded joint 1, the weld metal 20 may be formed from the sheet surface 12a to the sheet surface 12b of the steel sheet 12 in the sheet thickness direction.

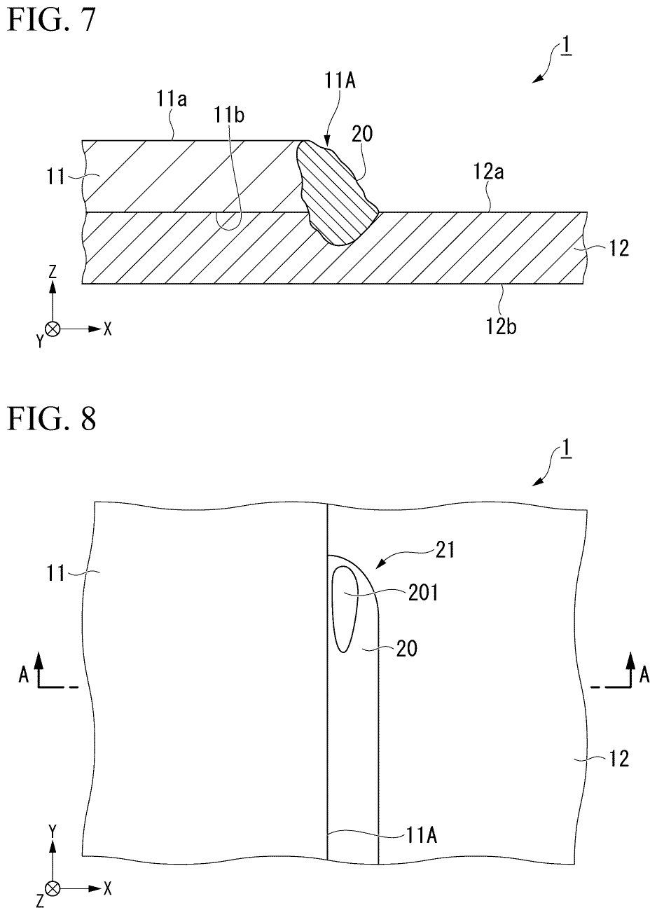

FIG. 7 is a schematic view of a cut end surface for explaining a laser fillet welded joint (also referred to as a laser lap fillet welded joint) in which steel sheets that are joined at least partially overlap each other and an end surface of one steel sheet is joined to a sheet surface of the other steel sheet. A cut surface of a laser welded joint 1 in FIG. 7 is a surface perpendicular to the extension direction of a weld metal (the traveling direction of laser beams) and parallel to the X-coordinate axis and the Z-coordinate axis. The laser welded joint 1 shown in FIG. 7 includes a steel sheet 11, a steel sheet 12 overlapped with the steel sheet 11, and a weld metal 20 formed over the end surface of the steel sheet 11 and the sheet surface of the steel sheet 12. The steel sheet 11 has one sheet surface 11a and the other sheet surface 11b. The steel sheet 12 has one sheet surface 12a and the other sheet surface 12b. In this example, the sheet surface 11b of the steel sheet 11 and the sheet surface 12a of the steel sheet 12 are opposed to each other.

In the example of FIG. 7, the weld metal 20 is formed over the whole sheet thickness direction of the steel sheet 11 in the end surface 11A of the steel sheet 11, and is formed from sheet surface 12a of the steel sheet 12 to the midway portion in the sheet thickness direction toward the sheet surface 12b. The weld metal 20 may be formed over the whole sheet thickness direction from the sheet surface 12a of the steel sheet 12 toward the sheet surface 12b.

FIG. 8 is a schematic plan view of the laser welded joint 1 viewed from the positive direction side of the Z-coordinate axis of FIG. 7. FIG. 7 is a view of a cut end surface of the laser welded joint 1 shown in FIG. 8, broken along the cross-sectional line A-A. The weld metal 20 is formed to extend along the Y-coordinate axis in the example of FIG. 8. The traveling direction of laser beams in the formation of the weld metal 20 is in the positive direction of the Y coordinate axis. A crater 201 is present in a terminal end part 21 of the weld metal 20.

In the above-described examples, the width and the length of the weld metal 20 formed by laser welding are not particularly limited, and may be designed to be appropriately adjusted according to a desired joint strength or a shape of the steel sheets that are joined. In addition, the shape of the weld metal 20 is not limited to a linear shape. The weld metal 20 may be curved or bent on the sheet surface of the steel sheet, for example.

In addition, in the present embodiment, the terminal end part 21 of the weld metal 20 is not necessarily positioned at an end part of the weld metal 20. In a case where the laser is moved slightly back along the weld line and the irradiation of laser beams ends at a part other than the end part of the weld metal, the terminal end part 21 having the crater 201 may be formed at a part other than the end part of the weld metal 20.

In the above-described examples, the steel sheet 11 and the steel sheet 12 that are joined have the same thickness. However, the thicknesses of the steel sheets that are joined are not particularly limited. The thickness (sheet thickness) of the steel sheet is measured at five points using a measurement instrument such as a caliper or a micrometer, and an arithmetic average value of the measured values is defined as the thickness of the steel sheet.

### (Crater in Terminal End Part)

The crater may be formed on either the side irradiated with laser beams or the opposite side in the terminal end part of the weld metal. After the end of laser welding, the welded part is rapidly cooled and constricted due to heat release from the welded part to the surrounding regions, and thus tensile stress in a direction perpendicular to the extension direction of the weld line is applied to the terminal end part of the weld metal. Due to the tensile stress applied to the terminal end part of the weld metal in which the crater is formed, the terminal end part of the weld metal may break in a direction perpendicular to the tensile stress (the extension direction of the weld line). In the laser welded joint according to the present embodiment, it is possible to prevent such breaking by satisfying the following requirements.

### (Vickers Hardness of Steel Sheet)

In the laser welded joint according to the present embodiment, at least one of the plurality of steel sheets is a high strength steel sheet having Vickers hardness of 320 HV or more. In a case where the above-described breaking occurs, there is a concern that the breaking of the terminal end part may progress along the extension direction of the weld metal and cracks may be formed over the whole weld metal. The higher the Vickers hardness of the steel sheet, the higher the susceptibility to hydrogen embrittlement cracking, and there is an increased concern that cracking may occur in the terminal end part of the weld metal. In a case where cracks occur over the entire length of the weld metal, the static strength of the joint part, such as shear strength and peeling strength, decreases, and the fatigue strength also significantly decreases. Therefore, cold-cracking is particularly problematic in the high strength steel sheet.

The Vickers hardness of the steel sheet is measured in accordance with JIS Z 2204. As a measurement position of the Vickers hardness, in a cross section cut to include the sheet thickness of the steel sheet, a position at a depth of ¼ of the sheet thickness in the sheet thickness direction is determined for measurement. In the measurement, the pressing load is set to 300 gf or more. The Vickers hardness of the steel sheet is measured at 10 points with a pitch of 0.2 mm, and an arithmetic average value of the measured values is calculated. The test piece is cut out from a flat part 5 mm or more away from the welded part.

The strength of the steel sheet is preferably as high as possible from the viewpoint of increasing the strength of the laser welded joint. For example, the Vickers hardness of one or more of the plurality of steel sheets may be 320 HV or more, 328 HV or more, or 363 HV or more. In addition, the Vickers hardness of all of the plurality of steel sheets may be 320 HV or more, 328 HV or more, or 363 HV or more. The higher the Vickers hardness of the steel sheet, the higher the susceptibility of the weld metal to hydrogen embrittlement cracking. However, in the laser welded joint according to the present embodiment, diffusible hydrogen is reduced, and the cold-cracking is suppressed by providing the requirements to be described below.

### (Tensile Strength of Steel Sheet)

In the laser welded joint according to the present embodiment, at least one of the plurality of steel sheets is preferably a high strength steel sheet having a tensile strength of 980 MPa or more. In a case where the above-described breaking occurs, there is a concern that the breaking of the terminal end part may progress along the extension direction of the weld metal and cracks may be formed over the whole weld metal. The larger the tensile strength of the steel sheet, the larger the tensile stress applied to the terminal end part of the weld metal after the end of laser welding, and there is an increased concern that cracking may occur in the terminal end part of the weld metal. In a case where cracks occur over the entire length of the weld metal, the static strength of the joint part, such as shear strength and peeling strength, decreases, and the fatigue strength also significantly decreases. Therefore, cold-cracking is particularly problematic in the high strength steel sheet.

The strength of the steel sheet is preferably as high as possible from the viewpoint of increasing the strength of the laser welded joint. For example, the tensile strength of one or more of the plurality of steel sheets may be 980 MPa or more, 1,000 MPa or more, or 1,100 MPa or more. In addition, the tensile strengths of all of the plurality of steel sheets may be 980 MPa or more, 1,000 MPa or more, or 1,100 MPa or more. The larger the tensile strength of the steel sheet, the larger the tensile stress applied to the terminal end part of the weld metal after welding. However, in the laser welded joint according to the present embodiment, diffusible hydrogen is reduced, and the cold-cracking is suppressed by providing the requirements to be described below.

The tensile strength of the steel sheet is measured in accordance with JIS Z 2241 by using a test piece cut out according to the component size from the steel sheet in accordance with JIS Z 2241. The test piece is cut out from a flat part 5 mm or more away from the welded part.

Both the Vickers hardness and the tensile strength of the steel sheet are parameters indicating the strength of the steel sheet. They can be converted into each other by Expression A. In the following Expression A, TS denotes a tensile strength of the steel sheet, and HV denotes Vickers hardness of the steel sheet.

$$TS = 2.87 \times HV + 59 \qquad Expression A$$

(Amount of Al Penetrated from Base Metal)

In the laser welded joint according to the present embodiment, the amount of Al penetrated from base metal of the plurality of steel sheets is more than 0.10 mass % and 2.10 mass % or less. The reason why the amount of Al penetrated from base metal is specified as described above is to supply Al necessary for stable formation of Al slag to be described below from the steel sheets that are joined to the weld metal.

The amount of Al penetrated from base metal is the sum of values, each obtained by multiplying the amount of Al in each steel sheet that is joined by the ratio of a penetration cross-section area of the steel sheet. That is, the amount of Al penetrated from base metal is defined by the following Expression B.

Amount of Al penetrated from base metal=([Ratio of Penetration Cross-Section Area of Steel Sheet 1]×[Al Content of Steel Sheet 1])+([Ratio of Penetration Cross-Section Area of Steel Sheet 2]×[Al Content of Steel Sheet 2]) . . . +([Ratio of Penetration Cross-Section Area of Steel Sheet n]×[Al Content of Steel Sheet n]) Expression B

In the laser lap welded joint or the laser butt welded joint described above, the penetration cross-section area of the steel sheet is an area where the weld metal is formed on the cut surface perpendicular to the sheet surface of each steel sheet that is joined. Specifically, the penetration cross-section area of each steel sheet is an area surrounded by the sheet surface and/or end surface of each steel sheet and the boundary between the steel sheet and the weld metal. In a case where the position of the sheet surface or the end surface of the steel sheet cannot be determined from the cut surface, the sheet surface or the end surface of a portion of the laser welded joint, where no weld metal is formed, may be extended to specify the position of the sheet surface or the end surface.

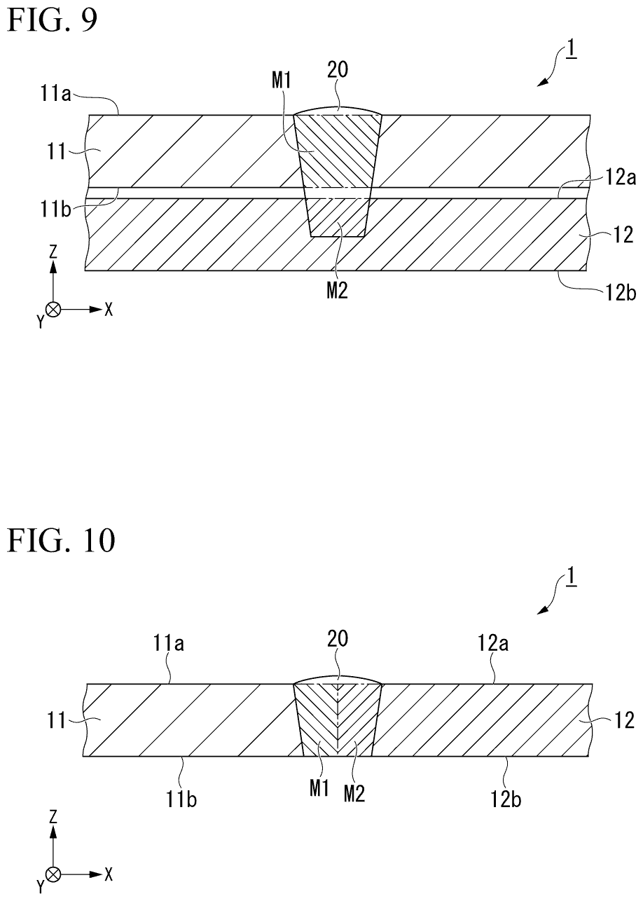

FIG. 9 shows a schematic view of a cut end surface for explaining an example of a penetration cross-section area of a steel sheet in a laser lap welded joint. In a laser lap welded joint 1 shown in FIG. 9, it is assumed that the Al content of a steel sheet 11 is 0.15 mass %, the Al content of a steel sheet 12 is 0.20 mass %, and both a thickness t1 of the steel sheet 11 and a thickness t2 of the steel sheet 12 are 1.6 mm. In the steel sheet 11, a weld metal 20 is formed over the whole sheet thickness direction of the steel sheet 11, and a penetration cross-section area m1 of a region M1 in the weld metal is 2.4 mm². In the steel sheet 12, the weld metal 20 is formed up to about halfway in the sheet thickness direction, and a penetration cross-section area m2 of a region M2 in the weld metal is 1.2 mm².

In the example of FIG. 9, sheet surfaces 11a, 11b, and 12a of the steel sheet 11 and the steel sheet 12 are extended in a direction along the X-coordinate axis to specify cross-section areas of the region M1 and the region M2. In FIG. 9, each of the region M1 and the region M2 is shown as a range surrounded by the dash-dot line in the weld metal 20.

The ratio of the penetration cross-section area of the steel sheet 11 is m1/(m1+m2)=2.4/(2.4+1.2), and the ratio of the penetration cross-section area of the steel sheet 12 is m2/(m1+m2)=1.2/(2.4+1.2). Therefore, Expression B is {2.4/(2.4+1.2)×0.15}+{1.2/(2.4+1.2)×0.20}, and the amount of Al penetrated from base metal is about 0.17 mass %.

FIG. 10 shows a schematic view of a cut end surface for explaining an example of a penetration cross-section area of a steel sheet in a laser butt welded joint. In the example of FIG. 10, end surfaces (not shown) of a steel sheet 11 and a steel sheet 12 butted against each other, where no weld metal is formed, are extended in a direction along the Y-coordinate axis, and a sheet surfaces 11a and 11b of the steel sheet 11 and sheet surfaces 12a and 12b of the steel sheet 12, where no weld metal is formed, are extended in a direction along the X-coordinate axis to specify cross-section areas of a region M1 and a region M2. The dash-dot lines in FIG. 10 indicate the lines extending from the sheet surfaces and the end surfaces of the steel sheets. In FIG. 10, the region M1 and the region M2 are each shown as a range surrounded by the dash-dot line in a weld metal 20. FIG. 10 corresponds to the view of the cut end surface of FIG. 3.

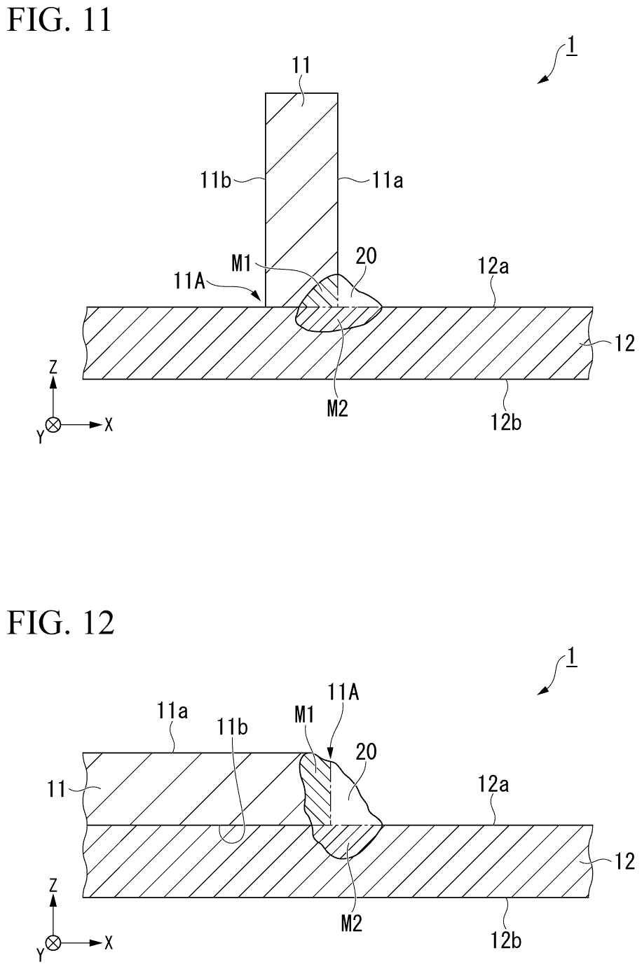

FIG. 11 shows a schematic view of a cut end surface for explaining an example of a penetration cross-section area of a steel sheet in a laser fillet welded T-joint. In the example of FIG. 11, an end surface 11A of a steel sheet 11 and a sheet surface 12a of a steel sheet 12, where no weld metal is formed, are extended in a direction along the X-coordinate axis, and a sheet surface 11a of the steel sheet 11 where no weld metal is formed is extended in a direction along the Z-coordinate axis to specify cross-section areas of a region M1 and a region M2. The dash-dot lines in FIG. 11 indicate the lines extending from the sheet surfaces and the end surfaces of the steel sheets. In FIG. 11, the region M1 and the region M2 are each shown as a range surrounded by the dash-dot line in a weld metal 20. FIG. 11 corresponds to the view of the cut end surface of FIG. 5.

FIG. 12 shows a schematic view of a cut end surface for explaining an example of a penetration cross-section area of a steel sheet in a laser lap fillet welded joint. In the example of FIG. 12, an end surface 11A of a steel sheet 11 at a portion where no weld metal is formed is extended in a direction along the Y-coordinate axis, and a sheet surface 11b of the steel sheet 11 and a sheet surface 12a of a steel sheet 12 where no weld metal is formed is extended in a direction along the X-coordinate axis to specify cross-section areas of a region M1 and a region M2. The dash-dot lines in FIG. 12 indicate the lines extending from the sheet surfaces and the end surfaces of the steel sheets. In FIG. 12, the region M1 and the region M2 are each shown as a range surrounded by the dash-dot line in a weld metal 20. FIG. 12 corresponds to the view of the cut end surface of FIG. 7.

The ratio of a penetration cross-section area of a steel sheet is a ratio of the penetration cross-section area to the sum of penetration cross-section areas of all steel sheets that are joined.

Portions of about 5 mm at start end and terminal end parts of a weld metal may be non-steady parts. Therefore, in the measurement of a penetration cross-section area of a steel sheet, a cross section of a portion excluding regions that are such non-steady parts is collected. The collected cross section is polished, and then etched with picral to measure a penetration depth by an optical microscope at a magnification of about 20 to 80. In the laser welding, the shape of penetration may slightly change due to pulsation, and thus about three cross sections are preferably collected for measurement. In a case where a plurality of cross sections are used for measurement, an arithmetic average of penetration cross-section areas is calculated as a penetration cross-section area of the steel sheet.

### (Average Al Content of Weld Metal)

In the laser welded joint according to the present embodiment, the average Al content of the weld metal is 0.30 mass % or more and 2.00 mass % or less. As will be described later, in order for slag containing Al to cover 30.0% or more of the surface of the weld metal, the average Al content of the weld metal needs to be 0.30% or more. In addition, the average Al content of the weld metal is more preferably 0.50% or more from the viewpoint of reliably forming the slag. In addition, in a case where the average Al content of the weld metal is adjusted to 2.00 mass % or less, the hardness of the weld metal does not decrease, and the joint strength of the welded part can be ensured.

The average Al content of the weld metal is measured by an emission spectrometric analysis method. As a sample used in the emission spectrometric analysis method, the whole weld metal excluding portions of 3 mm from the start end and terminal end parts is collected. However, in a case where the weld line is short and a sufficient sample amount cannot be ensured, the sample may be collected to include the start end and terminal end parts. Three samples are collected from this range, and an arithmetic average value of measured Al contents of the samples is defined as an average Al content.

When the average Al content of the weld metal is measured, the measurement is performed including the slag. For this, a cross section perpendicular to the extension direction of the weld metal is cut to be used as a sample for use in the emission spectrometric analysis method.

The weld metal can be visually distinguished from the steel sheet. Basically, the surface of the steel sheet is formed to have little irregularities. On the other hand, since the weld metal has been melted once, it has a wavy pattern called a ripple on the surface thereof in many cases, and the weld metal and the steel sheet can be distinguished from each other based on such a difference in surface.

### (Average Al Content, Average Si Content, and Average Mn Content of Weld Metal)

In the laser welded joint according to the present embodiment, when the average Al content, the average Si content, and the average Mn content of the weld metal are each denoted by [Al], [Si], and [Mn], the following Expression 1 is satisfied.

$$[ Al ] / ( [ Al ] + [ Si ] + [ Mn ] ) \geq 0.15 \qquad Expression 1$$

The average Si content and the average Mn content of the weld metal are measured by an emission spectrometric analysis method as in the measurement of the average Al content.

In Expression 1, the denominator indicates the sum of the amounts of elements that form oxides in the weld metal. The slag to be described below contains Al. The slag containing Al is more likely to spread on the surface of the weld metal and is more effective in suppressing the intrusion of hydrogen than slag containing other elements such as Si and Mn. By satisfying Expression 1, the area ratio of the slag containing Al covering the surface of the weld metal is 30.0%.

The right side of Expression 1 is more preferably 0.211, 0.250, 0.300, or 0.500. Therefore, the area ratio of the slag containing Al covering the surface of the weld metal can be more reliably ensured.

### (Area Ratio of Slag Containing Al)

In the laser welded joint according to the present embodiment, the slag containing Al covers 30% or more of the surface of the weld metal. In a case where the slag containing Al covers 30.0% or more of the surface of the weld metal, that is, in a case where the area ratio of the slag containing Al on the surface of the weld metal is 30.0% or more, the intrusion of hydrogen can be suppressed. From the viewpoint of increasing the hydrogen intrusion suppression effect, the area ratio of the slag containing Al is more preferably 32.0% or more, 50.0% or more, or 70.0% or more.

In order to adjust the area ratio of the slag containing Al on the surface of the weld metal to 30% or more, the above-described amount of Al penetrated from base metal needs to be more than 0.10 mass % and 2.10 mass % or less. That is, at least about 0.10 mass % of Al needs to be supplied from the base steel sheet to the weld metal. For example, in a case where Al is not supplied from the base steel sheet to the weld metal but supplied only from a filler material or plating, the Al concentration of the weld metal is not uniform, and a region where the Al concentration is insufficient is generated, so that the area ratio of the slag containing Al cannot be adjusted to 30.0% or more.

The area ratio of the slag containing Al on the surface of the weld metal is obtained by analyzing a center part of the weld metal by energy dispersive X-ray analysis (EDX). Specifically, the area ratio of the slag containing Al is obtained by the following procedure.

(1) A portion of the laser welded joint subjected to welding, excluding a start end part and a terminal end part of the weld metal, for example, a surface of a center part of the weld metal (a surface where the weld metal is formed) is observed by a scanning electron microscope (SEM).

The visual field of the observation by the SEM is set to be the weld metal's width or more (a range in which the whole weld metal in the visual field is included in the width direction of the weld metal) in the vertical direction (the width direction of the weld metal) and to be 3 to 5 times the width of the weld metal in the weld line direction in the horizontal direction (the weld line direction).

(2) In the entire visual field observed by the SEM, mapping analysis is performed by EDX to investigate the distribution of the slag containing Al on the surface of the weld metal. The EDX mapping image is taken with 1280×1024 pixels, and is shown in 256 levels (tone) in a range from the minimum value to the maximum value of the Al concentration. Examples of the device to be used include IT300 (acceleration voltage: 15 kV, irradiation current: 7.5 nA) manufactured by JEOL Ltd.

(3) Quantitative analysis is performed on any point to find a point at which the Al concentration is 3.0% (for example, 3.0% to 3.1%), and a pixel level (tone) on the mapping image corresponding to the position of the point is specified. The point analysis is performed under the same conditions (acceleration voltage: 15 kV, irradiation current: 7.5 nA) as the mapping analysis.

(4) In the EDX mapping image, pixels at a lighter level than the level (tone) specified in the paragraph (3) are determined as slag having an Al concentration of 3.0% or more and classified as white, and other pixels are classified as black and binarized. In a range of the weld metal (for example, between two broken lines shown in FIG. 14), the slag area ratio is calculated as (area ratio of slag containing Al)=(area of white part in range of weld metal in observed visual field)/(area of weld metal in observed visual field). Depending on the setting of the mapping image, pixels at a darker level than the level (tone) specified in the paragraph (3) may be determined as slag having an Al concentration of 3.0% or more and classified as black, and other pixels may be classified as white and binarized to calculate the slag area ratio as (area ratio of slag containing Al)=(area of black part in range of weld metal in observed visual field)/(area of weld metal in observed visual field). In addition, the treatments in (1) to (4) are performed a plurality of times (five times), and an average value of the calculated area ratios of a plurality (five) of slags is set as a final slag area ratio.

The center part of the weld metal is a range that is separated by a length of at least 0.4 mm or 0.3 times the width of the weld metal, whichever is shorter, from the boundary between the weld metal and the base steel sheet in a direction perpendicular to the extension direction of the weld metal in a portion excluding regions that are non-steady parts as described above. In the portion excluding regions that are non-steady parts, the width of the weld metal is measured at three points in a direction perpendicular to the extension direction of the weld metal, and an arithmetic average value of the measured values is defined as the width of the weld metal.

In a laser lap welded joint or a laser butt welded joint, the observation is performed using a scanning electron microscope from a direction perpendicular to the sheet surface of the base steel sheet. In a laser fillet welded T-joint or a laser lap fillet welded joint, the observation is performed using a scanning electron microscope while rotating the joint at any angle around the extension direction of the weld metal from a direction in which the surface of the weld metal is visible, and the value of the angle at which the highest Al concentration is detected is adopted as the Al concentration.

Then, the area of the weld metal in each visual field in which the Al element is mapped is calculated as shown in Expression C. A ratio of the area of the slag containing Al to the area of the weld metal is calculated, and an arithmetic average value of area ratios of the slags containing Al at all measurement portions is calculated as the area ratio of the slag containing Al.

$$Expression C$$

$$Area Ratio of Slag Containing Al = ( Area of Slag Containing Al ) / ( Area of Surface of Weld Metal )$$

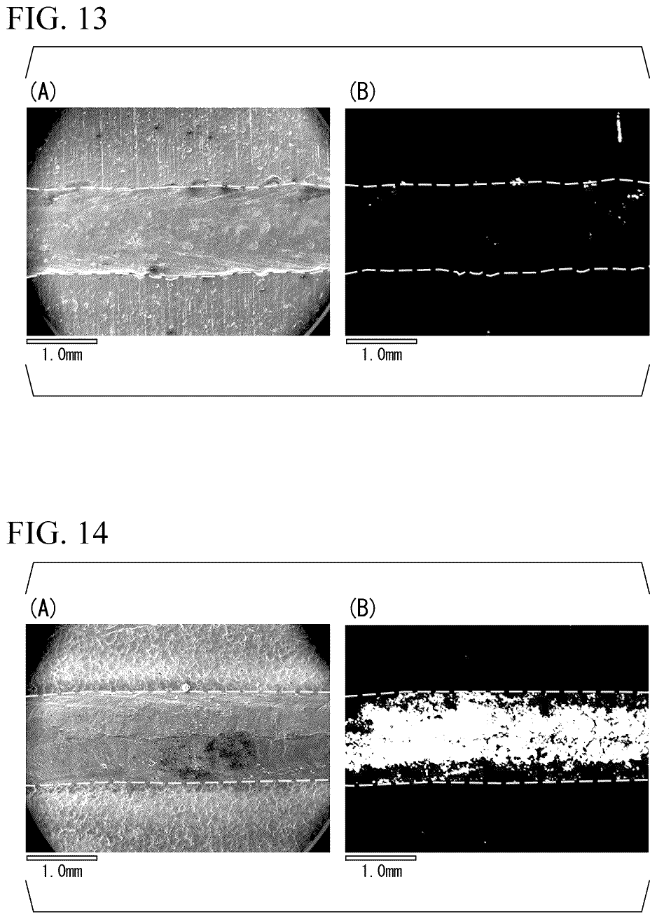

In each of FIGS. 13 and 14, (A) shows an example of an SEM image of a measurement portion, and (B) shows an example of an image obtained by binarizing a mapping image of Al at the measurement portion of (A). FIG. 13 shows an example in which the average Al content in the weld metal is 0.03 mass %, and FIG. 14 shows an example in which the average Al content in the weld metal is 0.70 mass %. As in these examples, the image in which the Al element is mapped is subjected to binarization conversion to calculate a ratio of an area relative to the area of the weld metal, and thus an area ratio of a range in which the slag containing Al covers the weld metal (the area ratio of the slag containing Al) can be calculated. In FIG. 14, white portions indicate slag containing Al. In addition, in FIGS. 13 and 14, the dashed lines each indicate the boundary between the surface of the weld metal and the surface of the steel sheet.

In the laser welded joint according to the present embodiment, the ratio of the average Al content of the weld metal to the amount of Al penetrated from base metal of the plurality of steel sheets is more preferably 0.80 to 1.20. As described above, in order for the slag containing Al to cover 30.0% or more of the surface of the weld metal, Al in the weld metal is preferably derived from the steel sheet that is a base metal. In a case where Al is supplied from the base metal to the weld metal, Al is uniformly supplied to the weld metal, and it is possible to sufficiently satisfy the requirement that the area ratio of the slag containing Al on the surface of the weld metal is 30.0% or more.

For example, in a case where a filler having an Al concentration that is higher than that of the base metal is used, Al is supplied to the weld metal not only from the steel sheet but also from the filler used during laser welding. In addition, Al may be supplied to the weld metal from a plating layer provided on the steel sheet. In these cases, the ratio of the average Al content of the weld metal to the amount of Al penetrated from base metal of the plurality of steel sheets is more than 1.00.

Meanwhile, in a case where Al is not contained in the plating or filler or the Al concentration of the plating or filler is lower than that of the base metal, Al contained in the molten steel may combine with oxygen and escape in small amounts as slag. In addition to the escape of Al as slag, the average Al concentration of the weld metal may be lower than the Al concentration of the base metal since the weld metal is formed by mixing of the plating or filler with the base metal. In these cases, the ratio of the average Al content of the weld metal to the amount of Al penetrated from base metal of the plurality of steel sheets is 1.00 or less.

In the laser welded joint according to the present embodiment, the chemical composition of the weld metal is more preferably as follows by mass %:
C: 0.1% to 0.6%;
Si: 0.005% to 3.0%;
Mn: 0.5% to 3.0%;
Al: 0.30% to 2.00%;
P: 0.04% or less;
S: 0.01% or less;
N: 0.1% or less;
O: 0.1% or less;
Cu: 0% to 1.0%;
Nb+Ti+V: 0% to 0.3%;
Ca+REM: 0% to 0.01%;
B: 0% to 0.005%;
Cr: 0% to 2.0%;
Ni: 0% to 1.0%;
Mo: 0% to 1.0%;
Sn: 0.1% or less;
Mg: 0% to 0.01%;
Sb: 0% to 0.1%;
As: 0% to 0.1%; and
a remainder: Fe and impurities.

Due to such a chemical composition, the laser welded joint according to the present embodiment has an advantage that the diffusible hydrogen concentration can be further reduced and the occurrence of cold-cracking can be further suppressed. The elements of the weld metal are measured by an emission spectrometric analysis method, and C and S are measured by an infrared absorption method.

In the laser welded joint according to the present embodiment, the plurality of steel sheets are more preferably non-plated steel sheets or zinc-based plated steel sheets. Al in the weld metal is preferably derived from the steel sheet that is a base metal. Therefore, in order to effectively use Al in the base metal, it is desirable to use a non-plated steel sheet or a zinc-based plated steel sheet. Examples of the plating include GI plating, GA plating, EG plating, Zn—Ni plating, and Zn—Mg plating.

All of the plurality of steel sheets may be non-plated steel sheets, or any of the plurality of steel sheets may be a non-plated steel sheet. Similarly, all of the plurality of steel sheets may be zinc-based plated steel sheets, or any of the plurality of steel sheets may be a zinc-based plated steel sheet.

In the laser welded joint according to the present embodiment, the Vickers hardness of the weld metal is preferably 450 HV or more HV or higher. In a case where the Vickers hardness of the weld metal is 450 HV or higher, the strength of the joint can be ensured. In the laser welded joint according to the present embodiment, the Vickers hardness of the weld metal is more preferably 500 HV or higher. In a case where the Vickers hardness of the weld metal is 500 HV or higher, the strength of the joint can be further ensured.

The Vickers hardness of the weld metal is measured by the following method. A laser welded joint including a weld metal is cut along a plane facing in a direction intersecting with the extension direction of the weld metal and perpendicular to the sheet surface of the joined steel sheet, and a sample is collected. The sample is polished (etching may be performed using, for example, picral after polishing to make the weld metal easily visible), and the hardness of the weld metal is measured at three or more points using a Vickers hardness meter in accordance with JIS Z 2244 (Vickers hardness test). An arithmetic average of the measured values is calculated as the Vickers hardness of the weld metal. The Vickers hardness can be measured under the conditions of a load of 300 gf, a pitch of 0.2 mm, and a holding time of 10 seconds, for example.

### [Manufacturing Method of Laser Welded Joint]

Hereinafter, a manufacturing method of the laser welded joint according to the present embodiment will be described. According to the manufacturing method, it is possible to suitably manufacture the laser welded joint 1 according to the present embodiment. However, it is obvious that, even a laser welded joint obtained by a method other than the manufacturing method to be described below is regarded as the laser welded joint 1 according to the present embodiment so long as the above-described requirements are satisfied.

The manufacturing method of the laser welded joint according to the present embodiment includes a step of preparing a plurality of steel sheets (S1: preparation step), a step of arranging the plurality of steel sheets (S2: arrangement step), and a laser welding step of forming the weld metal for joining the plurality of steel sheets (S3: laser welding step).

In the preparation step, steel sheets to be joined are prepared. As the thicknesses, chemical compositions, and the like of the steel sheets to be joined, those of the above-described embodiment can be adopted.

The steel sheets prepared in the above-described preparation step are arranged at predetermined positions in the arrangement step. In the arrangement step, the steel sheets are appropriately arranged according to the shape of a product to be manufactured, to constitute the laser lap welded joint, laser butt welded joint, or laser fillet welded joint described above.

The plurality of steel sheets arranged in the above-described arrangement step are subjected to laser welding in the laser welding step. In the laser welding step, the plurality of steel sheets are melted by irradiating the steel sheets with laser beams, and the melted metal solidifies between the plurality of steel sheets and forms a weld metal, and thus the plurality of steel sheets are joined to each other.

In the laser welding step according to the present embodiment, the laser welding is performed in an environment having an oxygen concentration of 3.0% or more. In addition of the constituent metals of the steel sheet, filler, and plating, elements in the external environment are incorporated into the portion where the metal is melted due to the laser beam irradiation (also referred to as a molten pool), but in a case where the chemical composition of the weld metal satisfies Expression 1 and the laser welding is performed in an environment having an oxygen concentration of 3.0% or more, an appropriate amount of oxygen can be supplied to the weld metal, and the area ratio of slag containing Al formed on the surface of the weld metal can be adjusted to 30.0% or more.

In the laser welding for a high strength steel sheet in the related art, a shielding gas such as argon was generally used to prevent oxidation. However, in the manufacturing method of the laser welded joint according to the present embodiment, the laser welding is performed in an environment having an oxygen concentration of 3.0% or more, and thus slag containing a desired amount of Al can be formed at a terminal end part of the weld metal.

Laser beam conditions are not particularly limited, but a solid laser device or a semiconductor laser device is preferably used from the viewpoint of productivity.

In the laser welding step, a filler may be used. The chemical composition of the filler is not particularly limited, but for example, a filler containing, as a chemical composition, Si: 0.5 to 0.8 mass %, Mn: 1.0 to 2.0 mass %, and Al: 0.50 to 1.00 mass %, or Si: 0.7 mass %, Mn: 1.5 mass %, and Al: 0.70 mass % may be used from the viewpoint of increasing the source of Al. In a case where Al is contained in the chemical composition of the filler, Al derived from the filler is also included in the weld metal.

The laser welded joint according to the embodiment can be preferably used for vehicle components. Examples of the vehicle components to which the laser welded joint according to the embodiment is applied include an A pillar, a B pillar, a roof rail, a side sill, a floor cross member, a bumper, a crash box, an instrument panel reinforcement, a seat frame, and a battery case. By applying the laser welded joint according to the present embodiment as a joint part of these components, it is possible to suppress cold-cracking, ensure the strength of the joint, and manufacture a product having excellent productivity.

### EXAMPLES

Hereinafter, the present invention will be described in detail with reference to examples, but is not limited to the examples.

Laser welded joints were created with steel sheets A to O, each having a chemical composition (with a remainder of Fe and impurities) shown in Table 1, based on various steel sheet combinations shown in Table 2. Specifically, two steel sheets were overlapped based on the steel sheet combination shown in Table 2 and subjected to laser lap welding.

The chemical composition of the steel sheet was measured by an emission spectrometric analysis method as described in the embodiment. The tensile strength and the sheet thickness of the steel sheet were measured by the methods described in the embodiment. The Vickers hardness of the steel sheet was calculated using Expression A on the basis of the tensile strength.

In examples using a filler, the filler contained, as a chemical composition, Si: 0.7 mass %, Mn: 1.5 mass %, and Al: 0.70 mass %.

In a laser welding step, the oxygen concentration was set as shown in Table 2. Conditions that did not satisfy the requirements of the present invention were underlined.

TABLE 1

| | | Tensile | Vickers | Sheet | | | | | | |
|---|---|---|---|---|---|---|---|---|---|---|
| | | Strength | Hardness | Thickness | Composition (mass %) | | | | | |
| | Plating | (MPa) | (HV) | (mm) | C | Si | Mn | P | S | Al |
| A | None | 2000 | 676 | 1.6 | 0.3 | 0.2 | 1.3 | 0.01 | 0.005 | 0.03 |
| B | None | 2000 | 676 | 1.6 | 0.3 | 0.2 | 1.3 | 0.01 | 0.005 | 0.10 |
| C | None | 2000 | 676 | 1.6 | 0.3 | 0.2 | 1.3 | 0.01 | 0.005 | 0.12 |
| D | None | 2000 | 676 | 1.6 | 0.3 | 0.2 | 1.3 | 0.01 | 0.005 | 0.20 |
| E | None | 2000 | 676 | 1.6 | 0.3 | 0.2 | 1.3 | 0.01 | 0.005 | 0.40 |
| F | None | 1800 | 607 | 1.6 | 0.3 | 0.2 | 1.3 | 0.01 | 0.005 | 0.70 |
| G | None | 1500 | 502 | 1.6 | 0.3 | 0.2 | 1.3 | 0.01 | 0.005 | 1.50 |
| H | None | 1200 | 398 | 1.6 | 0.3 | 0.2 | 1.3 | 0.01 | 0.005 | 2.05 |
| I | None | 1100 | 363 | 1.6 | 0.3 | 0.2 | 1.3 | 0.01 | 0.005 | 2.20 |
| J | None | 1500 | 502 | 1.6 | 0.2 | 1.5 | 2.5 | 0.01 | 0.005 | 0.70 |
| Ba | Al Plating | 2000 | 676 | 1.6 | 0.3 | 0.2 | 1.3 | 0.01 | 0.005 | 0.10 |
| Ca | Al Plating | 2000 | 676 | 1.6 | 0.3 | 0.2 | 1.3 | 0.01 | 0.005 | 0.12 |
| Fa | Al Plating | 1800 | 607 | 1.6 | 0.3 | 0.2 | 1.3 | 0.01 | 0.005 | 0.70 |
| Ga | Al Plating | 1500 | 502 | 1.6 | 0.3 | 0.2 | 1.3 | 0.01 | 0.005 | 1.50 |
| K | GA Plating | 1000 | 328 | 1.6 | 0.2 | 0.7 | 2.0 | 0.01 | 0.005 | 0.80 |
| L | GA Plating | 1000 | 328 | 1.6 | 0.2 | 1.5 | 2.3 | 0.01 | 0.005 | 0.03 |
| M | None | 2000 | 676 | 0.8 | 0.3 | 0.2 | 1.3 | 0.01 | 0.005 | 0.40 |
| N | None | 2000 | 676 | 2.3 | 0.3 | 0.2 | 1.3 | 0.01 | 0.005 | 0.40 |
| O | None | 2500 | 851 | 1.6 | 0.5 | 0.4 | 0.4 | 0.01 | 0.005 | 0.50 |

TABLE 2

| | | | Base | Average Al | Al Content | | | | Vickers | Area | | |
|---|---|---|---|---|---|---|---|---|---|---|---|---|
| | Steel | | Metal | Content | Ratio | | | Oxygen | Hardness | Ratio | | |
| | Sheet | | Penetration | of Weld | (Weld | Al + | | Concen- | of Weld | of Al | Result of | |
| | Combi- | | Al Content | Metal | Metal/Base | Si + Mn | Expres- | tration | Metal | Slag | Cracking | |
| No. | nation | Filler | (mass %) | (mass %) | Metal) | (mass %) | sion 1 | (%) | (HV) | (%) | Evaluation | |
| 1 | A-A | — | 0.03 | 0.02 | 0.67 | 1.020 | 0.020 | 21.0 | 544 | 3.9 | x | Comparative |
| | | | | | | | | | | | | Example 1 |
| 2 | B-B | — | 0.10 | 0.09 | 0.90 | 1.440 | 0.063 | 21.0 | 534 | 9.1 | x | Comparative |
| | | | | | | | | | | | | Example 2 |
| 3 | C-C | — | 0.12 | 0.10 | 0.83 | 1.350 | 0.074 | 21.0 | 519 | 15.4 | x | Comparative |
| | | | | | | | | | | | | Example 3 |
| 4 | D-D | — | 0.20 | 0.18 | 0.90 | 1.530 | 0.118 | 21.0 | 514 | 20.2 | x | Comparative |
| | | | | | | | | | | | | Example 4 |
| 5 | E-E | — | 0.40 | 0.33 | 0.83 | 1.568 | 0.211 | 21.0 | 521 | 32.2 | ∘ | Invention |
| | | | | | | | | | | | | Example 1 |
| 6 | F-F | — | 0.70 | 0.65 | 0.93 | 2.043 | 0.318 | 21.0 | 529 | 73.9 | ∘ | Invention |
| | | | | | | | | | | | | Example 2 |
| 7 | G-G | — | 1.50 | 1.30 | 0.87 | 2.600 | 0.500 | 21.0 | 509 | 80.1 | ∘ | Invention |
| | | | | | | | | | | | | Example 3 |
| 8 | H-H | — | 2.05 | 1.95 | 0.95 | 3.377 | 0.577 | 21.0 | 454 | 85.6 | ∘ | Invention |
| | | | | | | | | | | | | Example 4 |
| 9 | I-I | — | 2.20 | 2.10 | 0.95 | 3.532 | 0.595 | 21.0 | 412 | 80.1 | ∘ | Comparative |
| | | | | | | | | | | | | Example 5 |
| 10 | J-J | — | 0.70 | 0.65 | 0.93 | 4.364 | 0.149 | 21.0 | 499 | 28.1 | x | Comparative |
| | | | | | | | | | | | | Example 6 |
| 11 | Ba-Ba | — | 0.10 | 0.70 | 7.00 | 2.200 | 0.318 | 21.0 | 515 | 20.7 | x | Comparative |
| | | | | | | | | | | | | Example 7 |
| 12 | Ca-Ca | — | 0.12 | 0.90 | 7.50 | 2.400 | 0.375 | 21.0 | 503 | 37.8 | ∘ | Invention |
| | | | | | | | | | | | | Example 5 |
| 13 | Fa-Fa | — | 0.70 | 1.70 | 2.43 | 3.200 | 0.531 | 21.0 | 490 | 75.2 | ∘ | Invention |
| | | | | | | | | | | | | Example 6 |
| 14 | Ga-Ga | — | 1.50 | 2.20 | 1.47 | 3.700 | 0.595 | 21.0 | 442 | 86.0 | ∘ | Comparative |
| | | | | | | | | | | | | Example 8 |
| 15 | B-B | Presence | 0.10 | 0.40 | 4.00 | 1.900 | 0.211 | 21.0 | 480 | 4.1 | x | Comparative |
| | | | | | | | | | | | | Example 9 |
| 16 | C-C | Presence | 0.12 | 0.50 | 4.17 | 2.000 | 0.250 | 21.0 | 474 | 32.7 | ∘ | Invention |
| | | | | | | | | | | | | Example 7 |
| 17 | F-F | Presence | 0.70 | 0.70 | 1.00 | 2.200 | 0.318 | 21.0 | 464 | 78.8 | ∘ | Invention |
| | | | | | | | | | | | | Example 8 |
| 18 | H-H | Presence | 2.05 | 1.40 | 0.68 | 2.900 | 0.483 | 21.0 | 457 | 84.9 | ∘ | Invention |
| | | | | | | | | | | | | Example 9 |
| 19 | F-F | — | 0.70 | 0.65 | 0.93 | 2.043 | 0.318 | 2.0 | 520 | 5.4 | x | Comparative |
| | | | | | | | | | | | | Example 10 |
| 20 | F-F | — | 0.70 | 0.65 | 0.93 | 2.043 | 0.318 | 4.0 | 522 | 34.9 | ∘ | Invention |
| | | | | | | | | | | | | Example 10 |
| 21 | F-F | — | 0.70 | 0.65 | 0.93 | 2.043 | 0.318 | 10.0 | 528 | 50.9 | ∘ | Invention |
| | | | | | | | | | | | | Example 11 |
| 22 | F-F | — | 0.70 | 0.65 | 0.93 | 2.043 | 0.318 | 30.0 | 515 | 80.2 | ∘ | Invention |
| | | | | | | | | | | | | Example 12 |
| 23 | B-G | — | 0.80 | 0.75 | 0.94 | 1.950 | 0.385 | 21.0 | 525 | 32.7 | ∘ | Invention |
| | | | | | | | | | | | | Example 13 |
| 24 | K-K | — | 0.80 | 0.75 | 0.94 | 2.250 | 0.333 | 21.0 | 480 | 70.7 | ∘ | Invention |
| | | | | | | | | | | | | Example 14 |
| 25 | L-L | — | 0.03 | 0.02 | 0.67 | 1.520 | 0.013 | 21.0 | 485 | 7.1 | x | Comparative |
| | | | | | | | | | | | | Example 11 |
| 26 | D-E | — | 0.30 | 0.30 | 1.00 | 1.961 | 0.153 | 21.0 | 510 | 30.3 | ∘ | Invention |
| | | | | | | | | | | | | Example 15 |
| 27 | M-M | — | 0.40 | 0.37 | 0.93 | 1.841 | 0.201 | 21.0 | 542 | 33.3 | ∘ | Invention |
| | | | | | | | | | | | | Example 16 |
| 28 | N-N | — | 0.40 | 0.38 | 0.95 | 1.827 | 0.208 | 21.0 | 551 | 34.1 | ∘ | Invention |
| | | | | | | | | | | | | Example 17 |
| 29 | O-O | — | 0.50 | 0.47 | 0.94 | 1.243 | 0.378 | 21.0 | 644 | 45.8 | ∘ | Invention |
| | | | | | | | | | | | | Example 18 |

(Amount of Al Penetrated from Base Metal of Steel Sheet)

The amount of Al penetrated from base metal of the steel sheet was calculated based on the chemical composition of the steel sheet measured by the emission spectrometric analysis method and the ratio of a penetration cross-section area.

### (Average Al Content, Average Si Content, and Average Mn Content of Weld Metal)

The average Al content, the average Si content and the average Mn content of a weld metal were measured by the emission spectrometric analysis method as described in the embodiment. Expression 1 was calculated based on the measured values.

The ratio (Al content ratio) of the average Al content of the weld metal to the amount of Al penetrated from base metal of the plurality of steel sheets was calculated based on the measured values.

In addition, based on the measured values, the sum (Al+Si+Mn) of the average Al content, the average Si content, and the average Mn content of the weld metal was calculated.

### (Vickers Hardness of Weld Metal)

The Vickers hardness of the weld metal was measured for each of the laser welded joints of Nos. 1 to 29.

Specifically, the laser welded joint including the weld metal was cut along a plane facing in a direction intersecting with an extension direction of the weld metal and perpendicular to a sheet surface of the joined steel sheet, and a sample was collected. The sample was polished, etched with picral, and measured using a Vickers hardness meter by a method conforming to JIS Z 2244 (Vickers hardness test). With a load of 300 gf, a pitch of 0.2 mm between measurement positions, and a holding time of 10 seconds, the measurement was performed at a plurality of points positioned at a depth of ¼ of the sheet thickness from the sheet surface of the steel sheets opposed to each other along the joint interface between the steel sheets, and an arithmetic average of the measured values is calculated as Vickers hardness of the weld metal.

Steel sheets having Vickers hardness of 450 HV or more were evaluated as acceptable. This is because, when the weld metal has low Vickers hardness, the joint strength decreases.

### (Area Ratio of Slag Containing Al Covering Weld Metal)

For each of the laser welded joints of Nos. 1 to 29, an area ratio (Al slag area ratio) of slag containing Al covering the weld metal was measured in a center part of the weld metal. Specifically, the measurement was performed as follows.

To obtain the area ratio of slag containing Al on the surface of the weld metal, regions that were non-steady parts (a start end part and a terminal end part of the weld metal) of the laser welded joint were excluded for collection, and a center part of the weld metal described in the embodiment was analyzed by energy dispersive X-ray analysis (EDX) using a scanning electron microscope (IT300 manufactured by JEOL Ltd). Specifically, quantitative analysis was performed on the center part of the weld metal within the ranges described in the embodiment. In addition, as described in the embodiment, a portion where an Al concentration of 3.0% or more was recognized was determined as slag containing Al, and a threshold value for binarization was determined to obtain a binarized image.

As described in the embodiment, the area of the weld metal in the mapping image was calculated, and the area ratio of the slag containing Al relative to the area of the weld metal was calculated based on the binarized image.

### (Cracking Evaluation)

A cracking evaluation test was performed on the laser welded joints of Nos. 1 to 29.

Specifically, within 72 hours after welding, the laser welded joint including the weld metal was cut along a plane facing in a direction intersecting with the extension direction of the weld metal and perpendicular to the sheet surface of the joined steel sheet, and a sample was collected. The sample was polished, etched with picral, and observed by an optical microscope to determine the presence or absence of cracking. The test for cracking evaluation was performed three times. A case where no cracking occurred in all the tests was evaluated as “∘ (Good)”, and a case where cracking occurred at even one portion was evaluated as “x (Bad)”. Since cracking extended from a crater, the cracking evaluation was performed at a portion near (within 5 mm) the crater at the terminal end part. The test for cracking evaluation was performed on each laser welded joint a number of times of 3 (n3).

Comparative Examples 1 to 4, 6, 7, and 9 to 11 did not satisfy any of the requirements of the present invention, and cracking occurred in the weld metal and the heat-affected zone (HAZ).

In Comparative Examples 5 and 8, although the cracking was not observed, the Vickers hardness did not meet the standard.

Meanwhile, as can be understood from the results of Table 2, the laser welded joint according to the present invention shows good results in the cracking evaluation test, and the cold-cracking is suppressed. In addition, from the results of Table 2, it is found that, by appropriately controlling the oxygen concentration in the laser welding step, the area of the slag containing Al covering the terminal end part at the terminal end part of the weld metal can be adjusted to a desired range.

### INDUSTRIAL APPLICABILITY

According to a laser welded joint and a manufacturing method thereof according to the present invention, it is possible to suppress cold-cracking and ensure a strength of the joint, and thus the present invention is extremely useful in the industry.

### REFERENCE SIGNS LIST

1 Laser welded joint
11, 12 Steel sheet
20 Weld metal
21 Terminal end part
201 Crater

1. A laser welded joint comprising:
a plurality of steel sheets; and
a weld metal configured to join the plurality of steel sheets,
wherein at least one of the plurality of steel sheets is a high strength steel sheet having Vickers hardness of 320 HV or more,
an amount of Al penetrated from base metal of the plurality of steel sheets is more than 0.10 mass % and 2.10 mass % or less,
an average Al content of the weld metal is 0.30 mass % or more and 2.00 mass % or less,
when the average Al content, an average Si content, and an average Mn content of the weld metal are denoted by [Al], [Si], and [Mn], the following Expression (1) is satisfied, and
slag containing Al covers 30.0% or more of a surface of the weld metal,
$$[ Al ] / ( [ Al ] + [ Si ] + [ Mn ] ) \geq 0.15 . \qquad Expression 1$$

2. The laser welded joint according to claim 1,
wherein a ratio of the average Al content of the weld metal to the amount of Al penetrated from base metal of the plurality of steel sheets is 0.80 to 1.20.

3. The laser welded joint according to claim 1,
wherein the weld metal contains, as a chemical composition, by mass %,
C: 0.1% to 0.6%,
Si: 0.005% to 3.0%,
Mn: 0.5% to 3.0%,
Al: 0.30% to 2.00%,
P: 0.04% or less,
S: 0.01% or less,
N: 0.1% or less,
O: 0.1% or less,
Cu: 0% to 1.0%,
Nb+Ti+V: 0% to 0.3%,
Ca+REM: 0% to 0.01%,
B: 0% to 0.005%,
Cr: 0% to 2.0%,
Ni: 0% to 1.0%,
Mo: 0% to 1.0%,
Sn: 0.1% or less,
Mg: 0% to 0.01%,
Sb: 0% to 0.1%,
As: 0% to 0.1%, and
a remainder: Fe and impurities.

4. The laser welded joint according to claim 1,
wherein at least one of the plurality of steel sheets is a non-plated steel sheet or a zinc-based plated steel sheet.

5. The laser welded joint according to claim 1,
wherein Vickers hardness of the weld metal is 450 HV or more.

6. The laser welded joint according to claim 1,
wherein the laser welded joint is a laser lap welded joint, a laser butt welded joint, or a laser fillet welded joint.

7. The laser welded joint according to claim 1,
wherein at least one of the plurality of steel sheets is a high strength steel sheet having a tensile strength of 980 MPa or more.

8. The laser welded joint according to claim 1,
wherein one or more of the plurality of steel sheets contains, as a chemical composition, by mass %,
C: more than 0.15% and 0.5% or less,
Si: 0.1% to 3.5%,
Mn: 0.2% to 5.5%,
Al: more than 0.10% and 2.10% or less,
N: 0.1% or less,
O: 0.1% or less,
P+S: 0.050% or less,
Cu: 0% to 1.0%,
Nb+Ti+V: 0% to 0.3%,
Ca+REM: 0% to 0.01%,
B: 0% to 0.005%,
Cr: 0% to 2.0%,
Ni: 0% to 1.0%,
Mo: 0% to 1.0%,
Sn: 0.1% or less,
Mg: 0% to 0.01%,
Sb: 0% to 0.1%,
As: 0% to 0.1%, and
a remainder of Fe and impurities.

9. A manufacturing method of the laser welded joint according to claim 1, the method comprising:
a step of preparing the plurality of steel sheets;
a step of arranging the plurality of steel sheets; and
a laser welding step of forming the weld metal for joining the plurality of steel sheets,
wherein laser welding is performed in an environment having an oxygen concentration of 3.0% or more in the laser welding step.

10. The manufacturing method of the laser welded joint according to claim 9,
wherein, a solid laser device or a semiconductor laser device is used as a laser beam source in the laser welding step.
